(19) United States
(12) Patent Application Publication
(10) Pub. No.: US 2013/0313362 A1
(43) Pub. Date: Nov. 28, 2013

(54) Aircraft Ground Run-Up Protection Barrier For Propeller Equipped Planes

(71) Applicant: Michael Cardin, Lakeville, MA (US)

(72) Inventor: Michael Cardin, Lakeville, MA (US)

(21) Appl. No.: 13/899,506

(22) Filed: May 21, 2013

Related U.S. Application Data
(60) Provisional application No. 61/688,807, filed on May 22, 2012.

(51) Int. Cl. B64F 1/36

(52) U.S. Cl. CPC B64F 1/36
USPC 244/114 R

(57) ABSTRACT

A Protection Barrier adapted to provide a barrier between an aircraft propeller on one side, and an engine on the opposite side is disclosed. The protection barrier isolates a technician from a rotating propeller while performing engine maintenance, such as adjustments during an aircraft run-up procedure. The Protection Barrier includes a frame assembly supporting dual panels in an elevated position independently adjustable vertically, laterally, and for inclination.

### CROSS-REFERENCE TO RELATED APPLICATIONS

This application, claims the benefit of U.S. Provisional Application No. 61/688,807 filed 22 May 2012.

### FIELD OF THE INVENTION

This invention relates to aircraft ground run-up protection barriers, and more particularly to an aircraft ground run-up protection barrier that isolates a technician from a rotating propeller while performing engine maintenance, such as adjustments during an aircraft run-up procedure.

### BACKGROUND OF THE INVENTION

Ground run-ups are routine aircraft engine maintenance tests which require the operation of an engine at various power levels from idle to full for extended periods of time, and for propeller driven aircraft, while the propeller is rotating. Currently, ground run-ups are done on a remote taxiway, or runway on the airport with the aircraft pointed into the wind. In more congested areas, ground run-ups occur in a ground run-up enclosure, sometimes referred to as a “Hush House.”

During a run-up a technician may be working on the aircraft engine which is dangerously close to the spinning propeller. It is common practice for technicians to perform this maintenance at a safe distance away from the propeller, hoping accidents do not occur, which would assuredly be life threatening.

The present invention addresses this problem by providing an adjustable protection barrier or screen between the technician and propeller to provide safe isolation for maintenance on a propeller aircraft while it is running.

### SUMMARY OF THE INVENTION

In accordance with one embodiment of the present invention, a protection barrier comprises a frame portion configured for resting on a ground surface having at one end a first and second adjustment mechanism for independently adjusting first and second guard-member panels that make up the complete propeller guard.

The first and second adjustment mechanisms include at one end an adjustment for vertical and lateral positioning of the guard-member sections and at the opposite end an adjustment for pitch of the independent guard-member panels. The guard-member panels may be adjusted in substantially coextensive positioning or independently if desired.

### BRIEF DESCRIPTION OF THE DRAWINGS

FIG. 1 illustrates a perspective view of an Aircraft Ground Run-up protection barrier for Propeller equipped Planes.

FIG. 2 illustrates the attachment mechanism 32 of FIG. 1, to attach first and second guard-member panels 30A to first and second frame upper support portions 26.

FIG. 3 illustrates an extension arm that can be used to mate the protection barrier to the airplane engine mount.

FIG. 4 illustrates a perspective view of the first and second guard-member sections of FIG. 1, being opened laterally from the coextensive position of FIG. 1.

FIG. 5 illustrates the first and second guard-member sections of FIG. 1, in a substantially coextensive position.

FIG. 6 illustrates an aircraft propeller positioned through the opening created in the first and second guard-member sections of FIG. 1.

FIG. 7 illustrates a side view of an aircraft positioned for use with, the protection barrier of FIG. 1.

FIG. 8 illustrates a perspective view of the first and second guard-member sections of FIG. 1, being coextensive and in a pitched position relative to the ground surface.

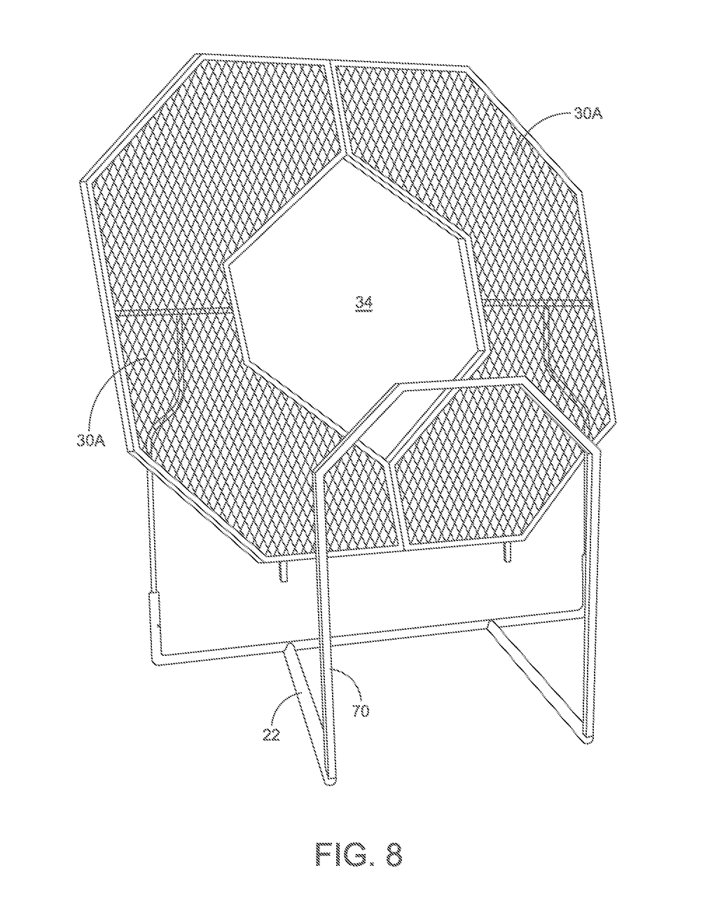

FIG. 9 illustrates a perspective view of the first and second guard-member sections of FIG. 1, one section being laterally disposed in relation to the opposite section.

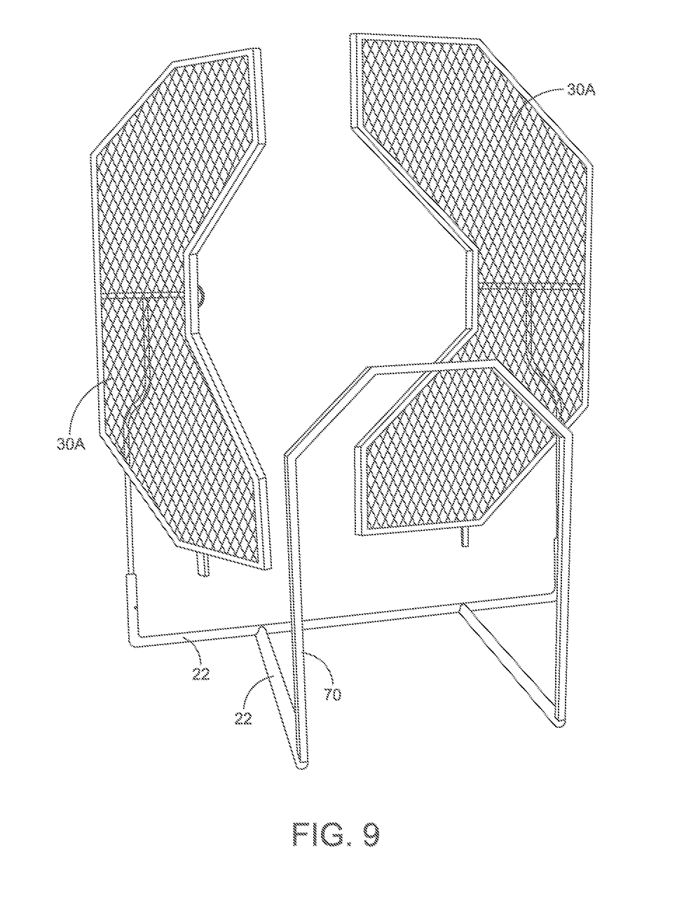

FIG. 10 illustrates a locking mechanism that can be used to secure guard member panel's 30A, described below, in a substantially coplanar position,

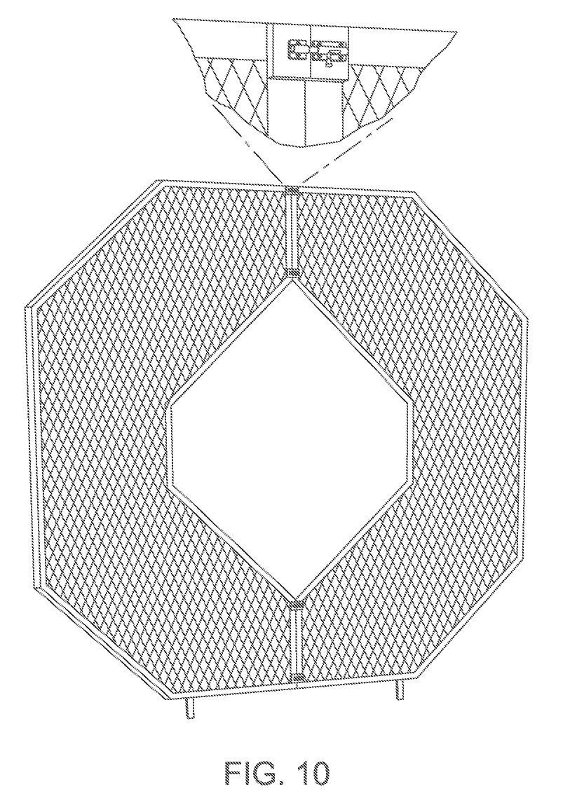

FIG. 11 illustrates the Protection Barrier described below and including an extension arm, tire chalk, and locking wheels for securing an airplane.

### DETAILED DESCRIPTION OF THE INVENTION

The following detailed description illustrates the invention by way of example and not by way of limitation. This description will clearly enable one skilled in the art to make and use the invention, and describes embodiments, adaptations, variations, alternatives and uses of the invention, including what I presently believe is the best mode of carrying out the invention. As various changes could be made in the above constructions without departing from the scope of the invention, it is intended that ail matter contained in the above description or shown in the accompanying drawings shall be interpreted as illustrative and not in a limiting sense.

While not shown, those skilled in the art will understand that the Aircraft Protection Barrier of the present invention is equally adaptable to other applications where an adjustable screen is necessary for isolation from dangerous physical conditions.

In view of the foregoing, it will be seen that the several objects of the invention are achieved and other advantageous results are obtained.

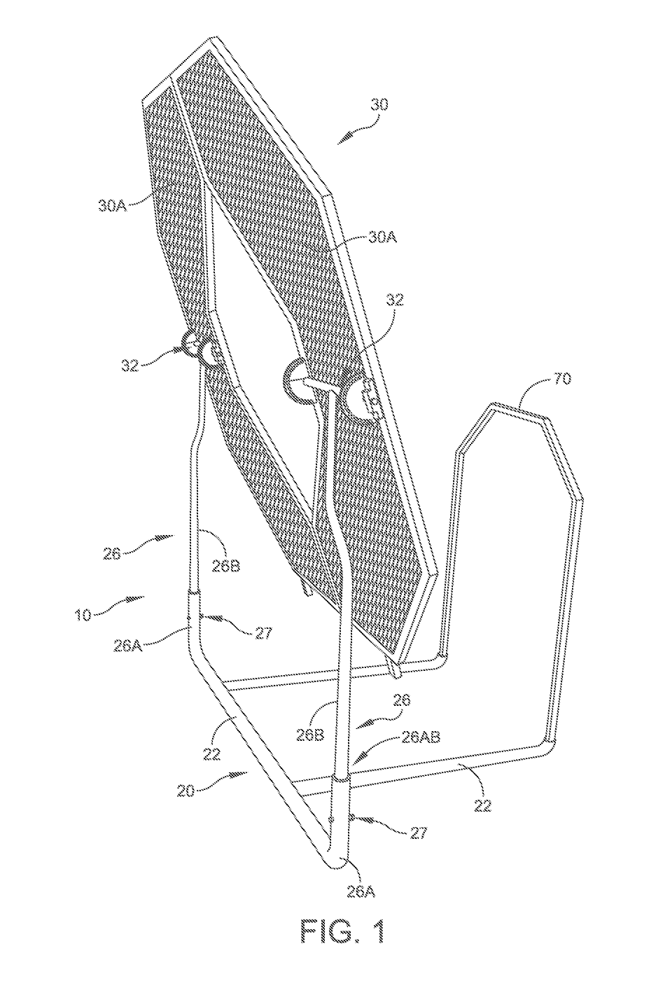

Referring FIG. 1, an embodiment of the present invention is illustrated; depicting a protection barrier 10 having a frame 20 configured for resting on a ground surface having at one end a first and second upward projecting support portion 26. The protection barrier includes positionable guard-member section 30, comprised of a first and second guard-member panels 30A supported by the first and second frame upward projecting support portion 26, the guard-members being adjustable independently in a vertical, lateral and pitching orientation.

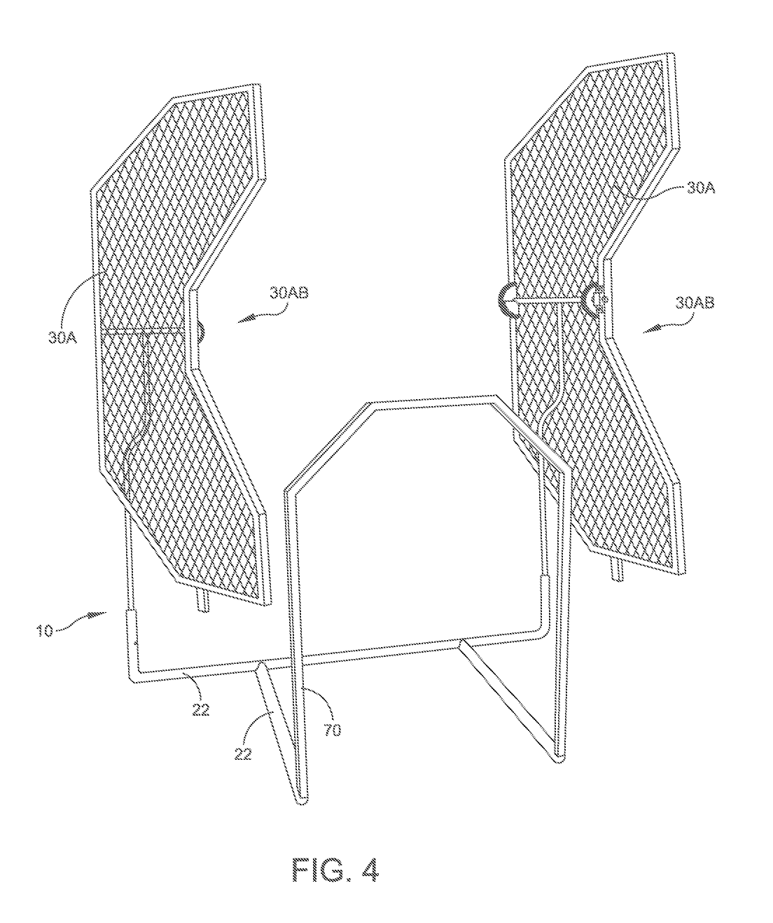

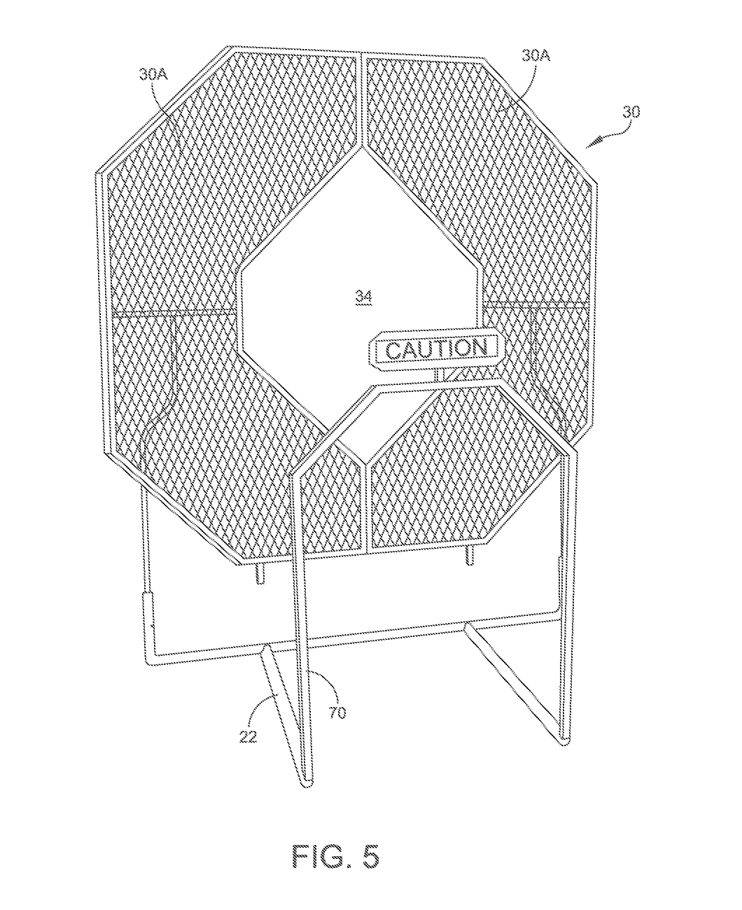

Referring to FIG. 4, guard-member panel's 30A may be laterally opened. At this point, an airplane would be guided inward into the protection barrier 10 towards a separation barrier 70. As illustrated in FIG. 5, separation barrier 70 may include a grill type mesh (not shown) with caution signs for people approaching the aircraft.

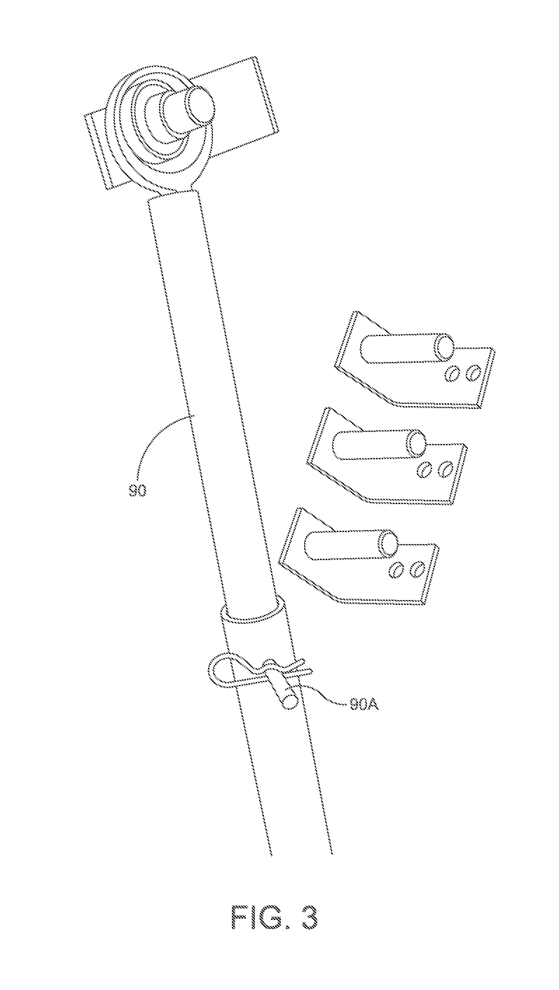

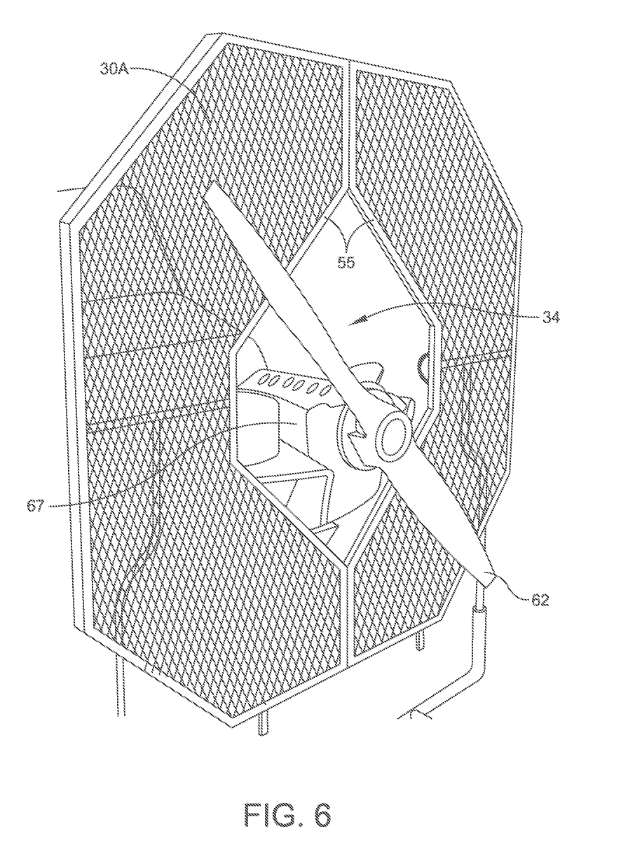

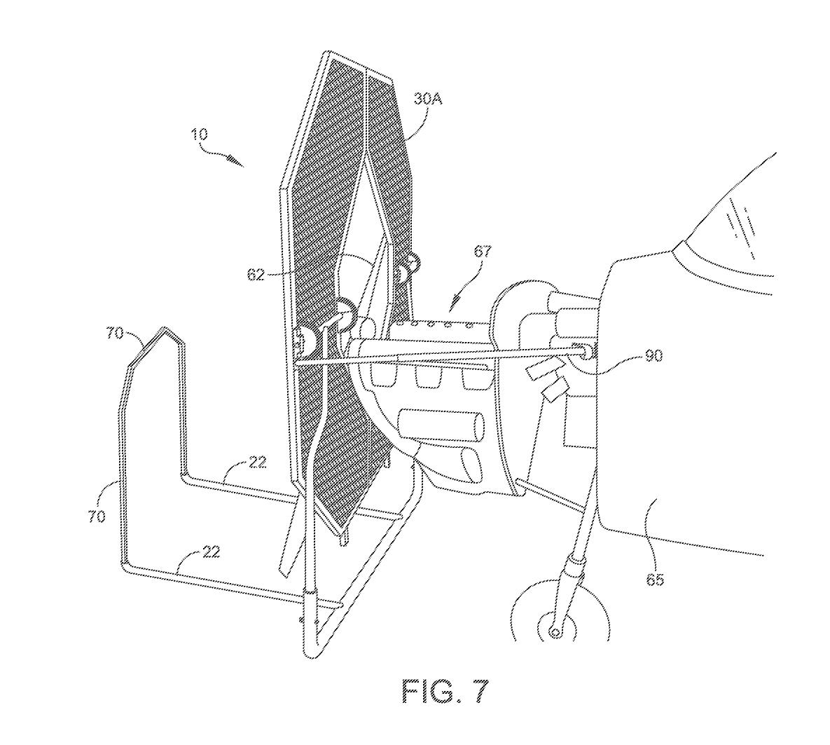

Next, first and second guard-member panels 30A are closed leaving the propeller 60 on the safe side of the barrier as illustrated in FIGS. 6 and 7. The frame structure of plane 65 may foe attached to protection barrier 10 to keep the barrier stationary during use, utilizing an extension arm 90 as illustrated in FIG. 3. Extension arm 90 can be any stiff adjustable rod or the like with attachment means at both ends for securement of the airplane to the protection barrier.

As illustrated in FIG. 7, the barrier 10 provides a safe environment for working on an airplane engine 67 while it is running and propeller 62 is spinning. First and second guard-member panels 30A include an edge recess 30AB (FIG. 4) that forms a single opening 34 when the guard-member panels 30A are closed and substantially coplanar (FIG. 5, 6).

The size of the opening 34 may be smaller or larger depending on the application. As illustrated in FIG. 1, a pitched protection barrier 10 is useful in applications for pitched type aircraft such as tail draggers. Further, depending on the height of the engine bay vertical adjustment of the barrier 10 may be necessary to facilitate use.

In one embodiment, and referring to FIG. 1, frame 20 includes a frame base 22 with upward projecting first and second frame upper support portions 26, extending vertically from frame base 22 and configured to support first and second guard-member sections 30A.

First and second frame upper support portions 26, are adjustable vertically by any means known in the art, and in one embodiment, include a first and second frame extension 26A, and a first and second locking extension 26B. Extension 26A includes an opening 26AB for slideable adjustment and locking of extension 26B at varying vertical positions within hole 26AB. Locking extension 26B is interlocking at one end 27 by interlocking reciprocating pins to selectively engage extension 26B at different vertical heights.

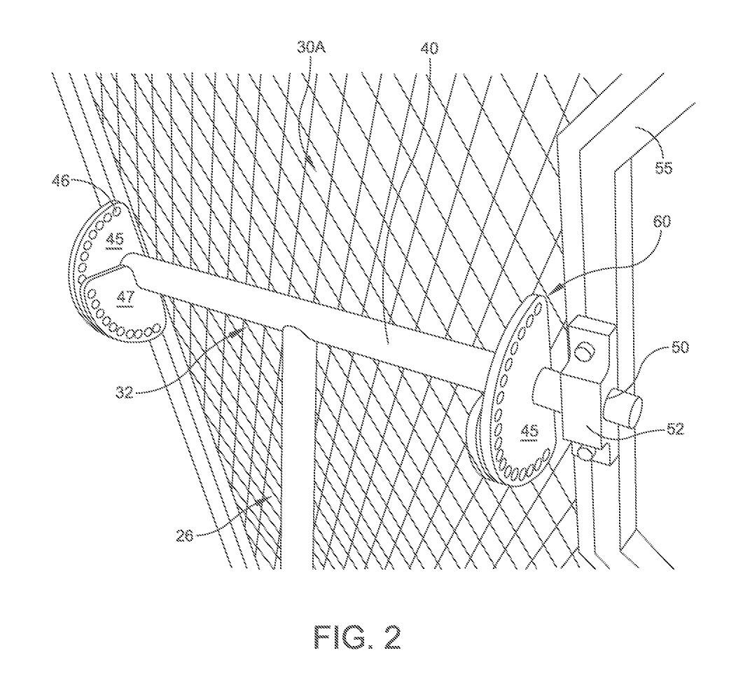

Referring to FIGS. 1 and 2, at the opposite end of first and second locking extension 26B is a guard-member attachment section 32, for securing first and second guard-member panels 30A such that guard-member sections 30A are positionable at varying pitching angles about attachment section 32.

Any attachment configuration known in the art that allows guard-member panels 30A to pitch to 180 degrees could be used. In the preferred embodiment, and referring to FIG. 2, guard-member attachment section 32 includes a cross member 40 in pivotal rotational engagement with first and second guard-member sections 30A. In the preferred embodiment, cross member 40 is cross sectionally positioned at the mid-section of first and second guard-member sections 30A as illustrated in FIG. 1 and FIG. 2.

In one embodiment, cross member 40, at opposite ends, rotatably engages a circular channel 50 of the peripheral frame 55 of guard-member sections 30A. In one embodiment, the circular channels are within a machined stanchion 52 affixed to the frame 55. Guard member attachment section 32 further includes a locking mechanism 60 for selectively fixing guard member panels 30A in a variety of pitched positions.

Any mechanism in the art may be used, however in the preferred embodiment, locking mechanism 60 includes a first interlocking section 45, movable with the pitching of guard-member panels 30A. Locking mechanism 60 further includes a stationary second interlocking section 47 affixed to cross-member 40. In one embodiment, both interlocking sections are semi-circular allowing for greater angular fixed positioning at various position apertures 46, when engaged by a locking pin.

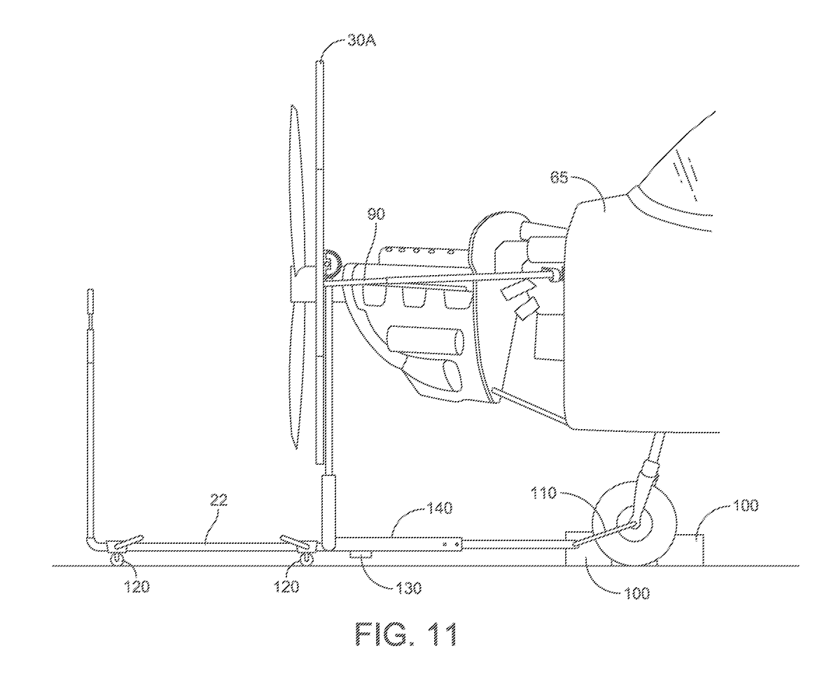

Referring to FIG. 11, an adjusting arm 90, with locking pin 90A is illustrated for securely positioning an aircraft at a distance from the Protection Barrier, via connection to an aircraft frame. A second adjusting arm 140, is utilised to connect frame 22 to locking wheel arm 110, and is adjustable lengthwise.

A tire chalk 100 being positionable away from and forward to the guard-member sections 30A is connected to locking wheel arm 110 which is connected to the wheel nuts, and is used for securement of an airplanes wheels therein. These securement means are necessary for proper positioning of the propeller within the protection barrier and stabilisation of the airplane when the propeller is spinning. The frame base 22 may also include retractable swivel wheels 120 and rubber shoes 130 for when the wheels are not in use. The rubber shoes 130 will contact the ground surface and provide grip when the swivel wheels 120 are retracted.

I Claim:

1. A Protection Barrier adapted to provide a barrier between an aircraft propeller on one side, and an engine on the opposite side, the aircraft having a fuselage, an engine, a propeller attached to the engine, and wheels attached to the fuselage, the Protection Barrier, comprising:
a guard member section adjustable vertically, laterally, and for inclination.

2. A Protection Barrier according to claim 1, further including a frame assembly, said frame assembly having a base configured for resting on a ground surface, said frame assembly having a first end and a second end, said first end projecting upward from said base and supporting said guard member section in an elevated position between the aircraft propeller on one side and the engine on the opposite side.

3. A Protection Barrier according to claim 2, wherein said guard member section further includes first and second guard member panels, said first and second guard member panels independently adjustable vertically, laterally, and for inclination.

4. A Protection Barrier according to claim 3, wherein said first end of said frame assembly comprises first and second upward projecting supports, said first upward projecting support having a first end and a second end and said second upward projecting support having a first end and a second end, said first guard member panel being rotatable about said first upward projecting support second end for varying inclination angles and said second guard member panel being rotatable about said second upward projecting support second end for varying inclination angles.

5. A Protection Barrier according to claim 4, wherein said first end of said first and second upward projecting supports are adjustable vertically and laterally to provide independent height adjustment and lateral adjustment to said first and second guard member panels.

6. A Protection Barrier according to claim 2, wherein said second end of said frame assembly is positioned forward of said first end, said second end projecting upward from said ground surface to provide a separation from said guard member section.

7. A Protection Barrier according to claim 4, wherein said first upward projecting support second end and said second upward projecting support second end each include an attachment section, said attachment section comprising a cross member, said cross member rotatably engaging said first and second guard member panels allowing for said guard member panels to be rotated about said cross member at various inclination angles, said attachment section further including a locking mechanism for securing said first and second guard member panels at said varying inclination angles.

8. A Protection Barrier according to claim 6, wherein said frame assembly base further includes retractable wheels for movement of said protection barrier.

9. A Protection Barrier according to claim 6, wherein said frame assembly base further includes an outward extending arm, said arm at one end attached to said frame assembly and at an opposite end attached to the aircraft wheels, said outward extending arm adjustable lengthwise for securing said aircraft in a fixed position.

10. A Protection Barrier according to claim 9, wherein said opposite end of said extending arm further includes a wheel arm and a tire chalk, said airplane wheels positioned within said tire chalk to prevent movement therein, said tire chalk attached to said wheel arm, said wheel arm attached to said opposite end of said extending arm.

11. A Protection Barrier according to claim 3, further including an adjusting arm connected at one end to at least one of said first and second guard member panels, and at the opposite end to said airplane fuselage, said adjusting arm adjustable lengthwise for securing said aircraft in a fixed position.

12. A Protection Barrier according to claim 3, wherein said first and second guard member panels each comprise recesses therein, said recesses forming a single opening when said first and second guard member panels are adjusted in a substantially coplanar orientation.
